(19) United States
(12) Patent Application Publication
(10) Pub. No.: US 2014/0095026 A1
(43) Pub. Date: Apr. 3, 2014

(54) Charging Control Unit and Method of Adjusting a Distance for an Inductive Charging Process

(71) Applicants: Gunter Freitag, Munchen (DE); Karl Josef Kuhn, Munchen (DE)

(72) Inventors: Gunter Freitag, Munchen (DE); Karl Josef Kuhn, Munchen (DE)

(21) Appl. No.: 14/040,596

(22) Filed: Sep. 27, 2013

(30) Foreign Application Priority Data
Sep. 28, 2012 (DE) DE 102012217779.5

(51) Int. Cl. B60L 11/18

(52) U.S. Cl. CPC B60L 11/1829
USPC 701/37

(57) ABSTRACT

A method of setting an optimized distance for inductive charging between a coil system of an inductive charging station and a coil system of an electric vehicle includes determining, by the inductive charging station, the optimized distance and calculating position data based on the optimized distance determined. The method also includes transferring the calculated position data to the electric vehicle and calculating a suspension construction for the electric vehicle based on the position data. The method includes transferring data on the calculated suspension construction to a suspension control device of the electric vehicle.

This application claims the benefit of DE 10 2012 217 779.5, filed on Sep. 28, 2012, which is hereby incorporated by reference.

### BACKGROUND

The present embodiments relate to a charging control unit and a method of adjusting a distance for an inductive charging process of an electric vehicle.

A charging cable may be used for charging electric vehicles at charging stations. Another known possibility for charging an electric vehicle is offered by inductive charging stations, whereby a system of coils is located both on, for example, the underside of the electric vehicle and in the charging station on the ground. Energy is transferred inductively from the charging station to the vehicle via an alternating magnetic field penetrating the coil system.

An inductive charging process may be carried out following positioning of the electric vehicle on the charging station without it being necessary for the driver of the vehicle to get out or for connection to a charging cable.

In order to charge an electric vehicle inductively with so little leakage and scattered radiation, the coil system of the charging station and the coil system of the electric vehicle are positioned so that the coil system of the charging station and the coil system of the electric system overlap as exactly as possible.

For example, it has been shown that, within permissible limits, transferable charging capacity is heavily dependent on the distance between the coil system of the vehicle and the coil system of the charging station. Precise adjustment of this distance thus enables the charging capacity to be increased without permissible limits being exceeded.

### SUMMARY AND DESCRIPTION

Current concepts take insufficient account of optimal distance. Rather, current inductive charging systems assume a fixed distance that may, however, vary within certain limits through positioning and loading.

Additional mechanically adjustable adjusting devices mounted on the electric vehicle have been proposed for setting an optimized distance. Adjustment in three directions (e.g., in a longitudinal or transverse direction, as well as vertically) in relation to the vehicle in order to optimize the distance between the coil system of the vehicle and the coil system of the charging station may be achieved by mechanical adjusting devices.

The practical application of such devices, meanwhile, has received much criticism, as comparable adjusting devices mounted on the underside of electric vehicles include extensive safety mechanisms and represent considerable additional weight. There has thus been little enthusiasm for further development of the adjusting devices described.

Alternative adjustable devices provided on the charging station require high levels of maintenance and are susceptible to weathering, so are technically unsuitable.

The scope of the present invention is defined solely by the appended claims and is not affected to any degree by the statements within this summary.

The present embodiments may obviate one or more of the drawbacks or limitations in the related art. For example, a device for setting an optimized distance in an inductive charging process of an electric vehicle that dispenses with the need for additional mechanical adjusting devices is provided.

According to one embodiment, a charging control unit for an electric vehicle that is configured to set an optimized distance for inductive charging between a coil system of the electric vehicle and a coil system of an inductive charging station is provided. The charging control unit includes an interface for receiving position data, a processing unit (e.g., a processor) for calculating a suspension construction for the electric vehicle based on the position data, and an interface for transferring data on the calculated suspension construction to a suspension control device of the electric vehicle.

In one embodiment, a charging control unit for an inductive charging station that is configured to set an optimized distance for inductive charging between a coil system of the inductive charging station and a coil system of an electric vehicle is provided. The charging control unit includes a device for determining the optimized distance and for calculating position data based on the optimized distance determined, and an interface for transferring the position data to the electric vehicle.

One or more of the present embodiments uses a method of setting an optimized distance for inductive charging between a coil system of an inductive charging station and a coil system of an electric vehicle.

The method of setting an optimized distance for inductive charging between a coil system of an inductive charging station and a coil system of an electric vehicle includes determining, by the charging station, the optimized distance and calculating position data based on the optimized distance determined. The method also includes transferring the position data calculated to the electric vehicle. The method includes calculating a suspension construction for the electric vehicle based on the position data and transferring data on the calculated suspension construction to a suspension control device of the electric vehicle.

One or more of the present embodiments provides connection of suspension controls with charging controls to provide an inductive charging process with optimal charging capacity without the provision of any additional mechanical device.

Also, one or more of the present embodiments advantageously enables compensation, through appropriate vertical adjustment, for errors in the longitudinal and/or transverse positioning of the electric vehicle in relation to the charging station that would currently require repositioning of the vehicle.

### BRIEF DESCRIPTION OF THE DRAWINGS

FIG. 1 is a schematic representation of an exemplary embodiment of functional components involved in the inductive charging of an electric vehicle.

### DETAILED DESCRIPTION

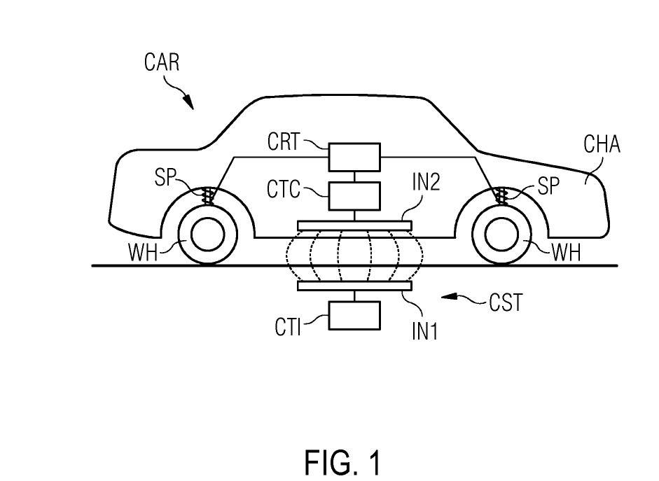

FIG. 1 shows one embodiment of a two-axled electric vehicle CAR with four wheels WH, positioned above an inductive charging station CST. The inductive charging station CST is disposed essentially below a shelf of the electric vehicle CAR and includes a first coil system IN1 and a charging control unit CTI as part of the charging station CST. Energy from the first coil system IN1 is transferred to a coil system IN2 assigned to the electric vehicle CAR via an alternating inductive field.

On an electric vehicle CAR, suspension elements SP of the electric vehicle CAR are disposed between bodywork CHA and wheel suspensions of vehicle wheels WH. The suspension elements SP retain the bodywork CHA above the wheels WH.

The electric vehicle CAR has an active suspension system, the traditional mechanical components of which, such as steel springs and shock absorbers, are replaced by suspension elements SP with which the position of the electric vehicle may be adjusted with the aid of command signals. Depending on requirement, active suspension systems using electrically driven or pneumatically and/or hydraulically driven suspension elements SP may be employed.

Control of the suspension elements SP for adjusting ground clearance of the electric vehicle CAR and for altering shock absorption is effected by a suspension control device CRT disposed in the electric vehicle CAR.

According to one embodiment, the adjustability of the ground clearance of the electric vehicle CAR through control of the suspension elements SP makes it possible to set an optimized distance for inductive charging between a second coil system IN2 and a first coil system IN1.

According to one or more of the present embodiments, a charging control unit CTC is provided in the electric vehicle CAR. The charging control unit CTC includes an interface for receiving position data. The position data is transmitted from the charging control unit CTC of the charging station. A processor of the charging control unit CTC calculates a suspension construction for the electric vehicle CAR based on the position data. Data on the calculated suspension construction is transferred to the suspension control device CRT of the electric vehicle CAR via an interface of the charging control unit CTC.

The inductive charging station has a—device for determining the optimized distance and for calculating position data based on the determined optimized distance (e.g., a processor).

According to one embodiment, the optimization of the distance between the two coil systems IN1, IN2 is achieved by enhanced charging process control. Bidirectional wireless exchange of data for determining the optimized distance between the charging control unit CTI of the charging station and the charging control unit CTC of the vehicle is provided.

The charging process control includes the provision of sensor data by sensors in the inductive charging station CST. Such data is used to determine an optimized distance between the two coil systems IN1, IN2. Position data is calculated based on the optimized distance determined and is transferred from the charging control unit CTI of the charging station to the charging control unit CTC of the electric vehicle CAR.

According to one embodiment, the bidirectional exchange of data is used for an iterative process in which an initially set distance is tested with a test charge. The results of this test charge are transmitted from the electric vehicle CAR to the charging control unit CTI of the inductive charging station CST where, if necessary, a further optimized distance is determined, on the basis of which corrected position data is transmitted to the electric vehicle CAR.

The suspension construction of the electric vehicle CAR is calculated in the charging control unit CTC of the electric vehicle CAR based on the position data transferred. The data on the suspension construction calculated is transferred to the suspension control device CTC.

The suspension control device CTC acts on the suspension elements SP such that an optimal setting for the distance between the coil systems IN1, IN2 is achieved by lowering or raising the electric vehicle CAR.

As long as the electric vehicle CAR is charged on the charging station CST, the electric vehicle CAR remains at the set height. When the charging process or the time the vehicle CAR spends on the charging station CST ends, the vehicle CAR returns to the optimal height for operation.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A charging control unit for an electric vehicle, the charging control unit being configured to set an optimized distance for inductive charging between a coil system of the electric vehicle and a coil system of an inductive charging station, the charging control unit comprising:
an interface configured to receive position data;
a processor configured to calculate a suspension construction for the electric vehicle based on the position data; and
an interface configured to transfer data on the suspension construction calculated to a suspension control device of the electric vehicle.

2. The charging control unit as claimed in 1, further comprising a device configured for bidirectional exchange of data, the optimized distance between the coil system of the inductive charging station and the coil system of the electric vehicle being determinable using the device configured for bidirectional exchange of data.

3. An electric vehicle with an active suspension system for regulating level, the electric vehicle comprising:
a coil system; and
a charging control unit configured to set an optimized distance for inductive charging between the coil system of the electric vehicle and a coil system of an inductive charging station, the charging control unit comprising:
an interface configured to receive position data;
a processor configured to calculate a suspension construction for the electric vehicle based on the position data; and
an interface configured to transfer data on the suspension construction calculated to a suspension control device of the electric vehicle.

4. A charging control unit for an inductive charging station, the charging control unit configured to set an optimized distance for inductive charging between a coil system of the inductive charging station and a coil system of an electric vehicle, the charging control unit comprising:
means for determining the optimized distance and for calculating position data based on the optimized distance determined; and
an interface configured to transfer the position data to the electric vehicle.

5. The charging control unit as claimed in claim 4, wherein the means for determining comprises means for bidirectionally exchanging data for determining the optimized distance.

6. An inductive charging station comprising:
a coil system;
a charging control unit configured to set an optimized distance for inductive charging between the coil system of the inductive charging station and a coil system of an electric vehicle, the charging control unit comprising:
means for determining the optimized distance and for calculating position data based on the optimized distance determined; and
an interface configured to transfer the position data to the electric vehicle.

7. A method of setting an optimized distance for inductive charging between a coil system of an inductive charging station and a coil system of an electric vehicle, the method comprising:
determining, by the inductive charging station, the optimized distance and calculating position data based on the determined optimized distance;
transferring the calculated position data to the electric vehicle;
calculating a suspension construction for the electric vehicle based on the position data; and
transferring data on the calculated suspension construction to a suspension control device of the electric vehicle.
